(19) United States
(12) Patent Application Publication
(10) Pub. No.: US 2013/0076889 A1
(43) Pub. Date: Mar. 28, 2013

(54) DISPLAY DEVICE AND DISPLAY METHOD

(71) Applicants: Daniel Bublitz, Rausdorf (DE); Christoph Nieten, Jena (DE); Enrico Geissler, Jena (DE); Thomas Mohr, Jena (DE); Artur Hoegele, Oberkochen (DE)

(72) Inventors: Daniel Bublitz, Rausdorf (DE); Christoph Nieten, Jena (DE); Enrico Geissler, Jena (DE); Thomas Mohr, Jena (DE); Artur Hoegele, Oberkochen (DE)

(21) Appl. No.: 13/624,913

(22) Filed: Sep. 22, 2012

(30) Foreign Application Priority Data
Sep. 23, 2011 (DE) 102011083354.4

(51) Int. Cl. H04N 7/18

(52) U.S. Cl. 348/80; 348/E07.085

(57) ABSTRACT

A display device includes an image acquisition module which has an image sensor and a first focal plane, which captures a picture of an object, and an observation module which images the object such that a user can perceive it with his eye. A second focal plane is set by the observation module and the accommodation state of the eye, and with a measuring module for measuring the accommodation state of the eye. A control unit adjusts the position of the first focal plane on the basis of the measured accommodation state such that it coincides with the second focal plane.

### PRIORITY

The present application claims priority to German Application No. 102011083354.4, filed Sep. 23, 2011, which is hereby incorporated herein by reference in its entirety.

### FIELD

The present invention relates to a display device with an image acquisition module, having an image sensor and a first focal plane, which captures a picture of an object, an observation module which images the object such that a user can perceive it with his eye, wherein a second focal plane is set by the observation module and the accommodation state of the eye, as well as a display method in which a picture of an object is captured with an image acquisition module having an image sensor and a focal plane, and the object is imaged with an observation module such that a user can perceive it with his eye, wherein a second focal plane is set by the observation module and the accommodation state of the eye.

### BACKGROUND

Conventional display devices in the above-noted field can be formed e.g. as a light microscope, surgical microscope, spotting scope, slit lamp or fundus camera, wherein the object imaged with the observation module for observation by the user is captured at the same time by means of the image acquisition module. This capture is carried out e.g. for documentation purposes and/or for a later evaluation and observation of the object.

If the eye of the user has a defective vision, the first and second focal planes do not lie one on top of the other. The result of this is that the image acquisition module delivers unsharp images compared with what the user sees. For this reason, a so-called dioptre adjustment is often provided which the user can adjust in order to make possible a match between the two focal planes. However, it has been shown that the user often incorrectly adjusts the dioptre adjustment, with the result that unsharp images are often generated in practice.

In addition, because of the purely optical eye lens, the user has the possibility, in the observation module, of moving the second focal plane by accommodating the eye. In this way, he can procure e.g. a three-dimensional overview of the object. This is not possible for the image acquisition module, with the result that the pictures of the image acquisition module do not correspond to what the user has seen through the purely optical observation module.

If the image acquisition module is used for documentation in a light or surgical microscope, it results in the documented pictures possibly not showing the decisive details, as the user has focused his eye differently to the image acquisition module.

If the image acquisition module provides a digital camera image to a second observer, the second observer does not see the same thing as the user of the display device using the purely optical observation channel.

When photographing with a spotting scope, the pictures are unsharp compared with the scene that the user has chosen when adjusting the observation module. This can be critical for nature photographers and hunters, but also in military applications or in border control.

In documentation in slit lamps and fundus cameras, the documented pictures possibly also do not show the decisive details, as the user (for example the ophthalmologist) has focused his eye differently to the image acquisition module. This results in the disadvantage that the pupil of the patient closes, with the result that the capture can be repeated only after several minutes.

### SUMMARY

It is an object of certain embodiments of the invention to provide a display device of the type named at the beginning, as well as a display method of the type named at the beginning, such that the difficulties described above are addressed.

The object is achieved according to certain embodiments with a display device of the type named at the beginning in that a measuring module is provided for measuring the accommodation state of the eye and a control unit is provided which adjusts the position of the first focal plane on the basis of the measured accommodation state such that it coincides with the second focal plane.

According to certain embodiments of the invention, the position of the first focal plane thus tracks the position of the second focal plane, which can be altered by alteration of the accommodation state of the eye of the user, with the result that what the user perceives in sharp definition via the observation module is always captured.

The observation module is preferably formed as a purely optical module.

In other words, according to certain embodiments of the invention the position of the focal plane of the digital channel (image acquisition module) of the display device tracks the position of the second focal plane of the purely optical channel (observation module).

In the display device according to certain embodiments of the invention, the image acquisition module includes a first lens system for imaging the object onto the image sensor. At least part of the lens system of the observation module is preferably also used for imaging onto the image sensor. If the observation module has at least one objective, the objective can also be used by the image acquisition module.

In the display device according to certain embodiments of the invention, the refractive power of the first lens system can be altered in order to adjust the position of the first focal plane. This can be realized for example by at least one element with variable refractive power and/or by several optical elements the position of which relative to each other is changed.

Furthermore, additionally or alternatively to altering the refractive power of the first lens system, the distance between the first lens system and the image sensor can be altered in order to adjust the position of the first focal plane.

In the display device according to certain embodiments of the invention, the measuring module can measure the accommodation state of the eye confocally. In particular, the measuring module can use infrared radiation (preferably with a wavelength from the range of from 800 to 1060 nm) to measure the accommodation state of the eye. The measuring module can measure the accommodation state e.g. continuously or periodically.

Furthermore, the measuring module can include a light source which emits a light beam, an optical system which guides the light beam into the eye of the user via the observation module, and a detector, wherein the light beam reflected at the fundus of the eye is directed via the observation module and the optical system onto the detector, which emits a detector signal which is used to measure the accommodation state.

Furthermore, in the display device according to certain embodiments of the invention, the image acquisition module and the measuring module can be moved at the same time, wherein the accommodation state of the eye is measured through the movement of the measuring module and the position of the first focal plane is adjusted through the movement of the image acquisition module. In particular, the movement of the image acquisition module can be carried out on the basis of the movement of the measuring module. Thus, the image acquisition module and the measuring module can e.g. be coupled together mechanically, with the result that the image acquisition module and the measuring module can only be moved at the same time.

The display device according to certain embodiments of the invention can be formed as a microscope (e.g. light microscope, surgical microscope), a spotting scope, a slit lamp or a fundus camera.

The object is furthermore achieved in certain embodiments of the invention with a display method of the type named at the beginning in that the accommodation state of the eye is measured and the position of the first focal plane is adjusted on the basis of the measured accommodation state such that it coincides with the second focal plane.

The display method according to certain embodiments of the invention can have the steps which are given in connection with the display device according to the invention (including its developments, as well as the description of embodiment examples yet to follow).

It is understood that the features mentioned above and those yet to be explained below can be used, not only in the stated combinations, but also in other combinations or alone, without departing from the scope of the present invention.

### BRIEF DESCRIPTION OF THE DRAWINGS

The invention is explained in further detail below by way of example using the attached drawings which also disclose features essential to the invention. There are shown in:

FIG. 1, which is a schematic view of a first embodiment of the display device according to the invention.

FIG. 2, which is a representation of the optical structure of the measuring module 8 of FIG. 1.

FIG. 3, which is a schematic representation of a further embodiment of the display device according to the invention.

### DETAILED DESCRIPTION

In the following descriptions, the present invention will be explained with reference to example embodiments thereof. However, these example embodiments are not intended to limit the present invention to any specific example, environment, embodiment, applications or particular implementations described in these example embodiments. Therefore, descriptions of these example embodiments are only for purposes of illustration rather than limitation to the invention. It should be appreciated that in the following example embodiments and the attached drawings, elements unrelated to the present invention are omitted from depiction; and dimensional relationships among individual elements in the attached drawings are illustrated only for ease of understanding, but not to limit the actual scale.

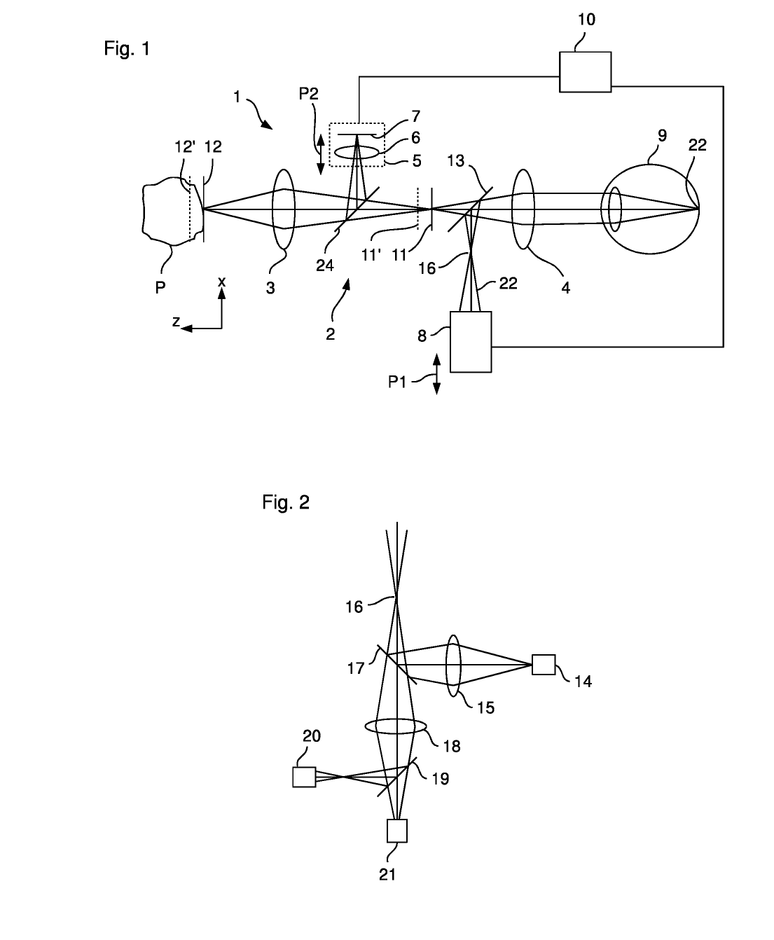

In the example embodiment shown in FIG. 1, the imaging device 1 according to the invention is formed as a monocular microscope with photo documentation and comprises an observation module 2 with an objective 3 and an eyepiece 4, an image acquisition module 5 with a first lens system 6 and an image sensor 7, a measuring module 8 for measuring the accommodation state of an eye 9 of a user, as well as a control unit 10.

With the observation module 2, the user can perceive a sample or an object P in magnification, wherein the objective 3 images the sample P into an intermediate image plane 11 and the user can perceive the sample imaged into the intermediate image plane 11 through the eyepiece 4.

If the user perceives the sample P in sharp definition, the eye 9 has an accommodation state with which the sample P imaged into the intermediate image plane 11 is perceived in sharp definition. A focal plane 12 is thus set by the accommodation state of the eye 9 and the optical properties of objective 3 and eyepiece 4.

If the user alters the fixation state or the accommodation state of the eye 9, another intermediate image plane 11′ is perceived in sharp definition through the eyepiece 4 or projected in sharp definition onto the retina of the eye 9. This then corresponds to a focal plane 12′ offset in z direction. In this way, the user can move the position of the focal plane 12 by altering the accommodation of his eye 9 in the projected sample in z direction.

The image acquisition module 5 is coupled into the observation beam path of the observation module 2 via a splitter 24 and formed such that it projects the focal plane 12 in sharp definition onto the image sensor 7. In order now to guarantee that the actual focal plane 12, 12′ onto which the user focuses with his eye 9 is always captured in sharp definition with the image acquisition module 5, the accommodation state of the eye 9 is continuously ascertained by means of the measuring module 8 and the position of the focal plane of the image acquisition module 5 is altered or adjusted on the basis of the measured accommodation state such that it coincides with the focal plane 12, 12′.

To measure the accommodation state of the eye 9, a measurement beam path 22 is coupled into the observation beam path of the observation module 2, and thus into the eye 9, via a splitter 13. A design of the measuring module 8 is shown in FIG. 2. The measuring module 8 contains a point light source 14, such as e.g. an LED, a laser source, in particular a VCSEL, an SLD (superluminescent diode), etc. The point light source 14 is projected into a plane 16, which is conjugate to the intermediate image plane 11, by means of a first measuring module lens system 15. As the measurement beam path 22 is coupled into the observation beam path via the splitter 13, the point light source 14 is imaged in a focused way onto the retina plane 22 of the eye 9.

The light scattered back from the retina of the eye 9 passes through the beam path in reverse direction and reaches a second measuring module lens system 18, which carries out a projection into a further intermediate image plane, through a second splitter 17. Between the second measuring module lens system 18 and the further intermediate image plane there is a third splitter 19 which projects the light, in roughly equal portions, onto two detectors 20, 21, wherein the detector 20 is arranged just behind the further intermediate image plane and the detector 21 just in front of the further intermediate image plane.

The intensity signal of the two detectors 20, 21 is fed to the control unit 10 which generates control signals from this for the image acquisition module 5 and for the measuring module 8. The control signals serve to move the measuring module 8 in x direction (double arrow P1) until the difference between the signals of the two detectors 20, 21 becomes zero. If the difference signal is zero, the plane 16 is conjugate to the intermediate image plane 11, 11′ onto which the user focuses.

The image acquisition module 5 is moved in x direction (double arrow P2) in accordance with the movement of the measuring module 8, in order to place the focal plane of the image acquisition module 5 such that it coincides with the focal plane 12, 12′ which the user perceives in sharp definition via the observation module. It is thus guaranteed that the image acquisition module 5 always captures the focal plane 12, 12′ onto which the user focuses.

In the design of the measuring module 8 shown in FIG. 2, all types of confocal sensors can be used for the detectors 20 and 21. It is also possible to provide only a single detector for measurement. In this case, the third splitter 19 can be dispensed with and the detector (e.g. detector 21) must be moved beyond the focal point. The position of the highest signal on the detector 21 is then a measure of the sought focal position. Such a sensor is constructed in a technically more simple way than the confocal sensors 20, 21 according to FIG. 2.

The confocal detectors 20 and 21 can be formed e.g. such as according to FIG. 2 of DE 10 2005 022 125 A1. The corresponding description in DE 10 2005 022 125 A1 is hereby incorporated by reference in its entirety. In these sensors, each position inside a wide capture range about the focal point can be measured with high precision and maintained. Such sensors would be used in a non-movable measuring module 8 and their focus error signal can be used directly to control the movement of the image acquisition module 5.

Wavefront sensors represent a further possibility for measuring the accommodation state of the eye 9. These use an illumination source similar to the confocal sensors and, on the illumination side, also the same beam path as in FIG. 2. However, on the detection side, the light is detected with a Shack-Hartmann sensor which, instead of the elements 18-21, has a spatially resolving sensor with lens systems (e.g. microlens array) divided in the pupil/aperture. A dot pattern then forms on the detector and the wavefront shape of the measurement light on leaving the eye 9 can be calculated from the distance between the dots on the detector. The accommodation state or the refraction value of the eye 9 can then be deduced from this wavefront shape.

As, for the application described here, only the curvature of the wavefront (=refraction value) of the eye 9 and not the precise shape of the wavefront is to be measured, significantly simplified Shack-Hartmann sensors with a few sub-apertures (e.g. two, four or six) are sufficient.

In the embodiments described up to now, the first lens system 6 was moved in x direction in the image acquisition module 5. However, it is also possible to provide variable optical elements the refractive power of which is changeable in order to alter the position of the focal plane of the image acquisition module 5. Free-form elements moved towards each other can also be used.

The focal position or the accommodation state of the eye 9 is preferably determined in the IR wavelength range.

In the description up to now, a monocular design of the imaging device 1 was the starting point. Naturally, the imaging device 1 can also be formed binocularly and the described adaptation can be carried out for each of the two eyes. Furthermore, when determining the accommodation of both eyes, an automatic dioptre adjustment between the eyes can be carried out.

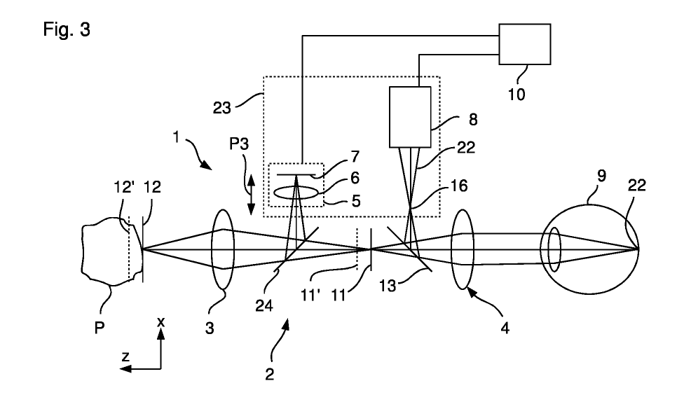

A modification of the embodiment according to FIG. 1 is shown in FIG. 3, wherein identical elements are given identical reference symbols and for the description thereof reference is made to the above statements. In the embodiment according to FIG. 3, the image acquisition module 5 and the measuring module 8 are coupled to each other mechanically such that they can be moved in x direction only at the same time (double arrow P3). Only one actuator (here e.g. a step motor) need be provided in order to move the two modules 5, 8. This is indicated by the dotted line 23.

In the embodiments described up to now, the beam splitters 13 and 24 are each arranged in a part of the observation beam path in which the radiation diverges or converges. Naturally, it is also possible to arrange the beam splitters 13 and 24 in a part of the observation beam path in which the radiation is collimated. It is also possible to provide a common beam splitter for the image acquisition module 5 and the measuring module 8 in the observation beam path. As the measuring module 8 uses infrared radiation and the image acquisition module 5 captures radiation from the visible wavelength range, it is then advantageous to arrange an additional absorption filter in front of the image sensor 7.

The measuring module 8 can be formed such that the light coming from the point light source 14 and focused onto the retina plane 22 of the eye 9 is polarized (e.g. linearly polarized). The detection of the back-scattered light by means of the detectors 20 and 21 is then detected linearly polarized perpendicular to the initial polarization. In this way, an almost polarization-crossed detection can be carried out, with the result that undesired scattered light which is reflected by other boundary surfaces and not by the retina is suppressed. For example, scattered light from the cornea and from the eyepiece 4 can be suppressed. The light reflected by the retina can be detected because the polarization of the light changes when passing through the cornea and when being scattered at the retina and thus can be partially transmitted and detected by the crossed detection polarizer. The precision of the method can thus be increased.

This can technically be carried out in that a corresponding polarizer is positioned in front of the point light source 14 and a corresponding polarizer in front of the two detectors 20 and 21. In particular, the beam splitter 17 e.g. can be designed as a polarizing beam splitter. Naturally, linear polarization need not be used. Other polarization states orthogonal to each other can also be used.

In addition, it is possible to provide an individual spatially resolving detector instead of the two detectors 20 and 21 and the beam splitter 19 in the measuring module 8, wherein the measured spot size (or the size of the circle of confusion) can be measured. Naturally, the intensity can also be measured in addition. The measurement signals are then fed to the control unit 6 in the described way.

The spatially resolving detector can be formed as a spatially resolving CMOS or CCD sensor or else as a surface-separated sensor with two or more individually releasable part-surfaces. Arrangements with extra-axial quadrant diodes or PSDs or else diode arrays are also possible.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A display device, comprising:
an image acquisition module, including an image sensor and a first focal plane, which captures a picture of an object;
an observation module which images the object such that a user can perceive it with the user's eye, wherein a second focal plane is set by the observation module and the accommodation state of the eye;
a measuring module configured to measure the accommodation state of the eye; and
a control unit configured to adjust the position of the first focal plane on the basis of the measured accommodation state such that it coincides with the second focal plane are provided.

2. The display device according to claim 1, wherein the image acquisition module includes a first lens system for imaging the object onto the image sensor.

3. The display device according to claim 2, wherein the refractive power of the first lens system is alterable in order to adjust the position of the first focal plane.

4. The display device according to claim 3, wherein the distance between the first lens system and the image sensor is alterable in order to adjust the position of the first focal plane.

5. The display device according to claim 2, wherein the distance between the first lens system and the image sensor is alterable in order to adjust the position of the first focal plane.

6. The display device according to claim 1, wherein the image acquisition module uses at least part of the observation module to capture a picture of the object.

7. The display device according to claim 1, wherein the measuring module measures the accommodation state of the eye confocally.

8. The display device according to claim 1, wherein the measuring module uses infrared radiation to measure the accommodation state of the eye.

9. The display device according to claim 1, wherein the measuring module continuously measures the accommodation state of the eye.

10. The display device according to claim 1, wherein the measuring module includes a light source which emits a light beam, an optical system which guides the light beam into the eye of the user via the observation module, and a detector, wherein the light beam reflected at the fundus of the eye is directed via the observation module and the optical system onto the detector, which emits a detector signal which is evaluated to measure the accommodation state.

11. The display device according to claim 1, wherein the image acquisition module and the measuring module are moved at the same time, wherein the accommodation state of the eye is measured through the movement of the measuring module and the position of the first focal plane is adjusted through the movement of the image acquisition module such that it coincides with the second focal plane.

12. The display device according to claim 11, wherein the image acquisition module and the measuring module are coupled together mechanically in order to be able to carry out the simultaneous movement.

13. A display method, comprising
capturing a picture of an object with an image acquisition module including an image sensor and a focal plane; and
imaging the object with an observation module such that a user can perceive it with his eye;
measuring the accommodation state of the eye;
setting a second focal plane by the observation module and the accommodation state of the eye; and
adjusting the position of the first focal plane on the basis of the measured accommodation state such that it coincides with the second focal plane.
